(19) United States
(12) Patent Application Publication
(10) Pub. No.: US 2024/0393797 A1
(43) Pub. Date: Nov. 28, 2024

(54) SYSTEMS AND METHODS FOR CONTROLLING MOBILE DEVICE MOVEMENT

(71) Applicant: APPLE INC., Cupertino, CA (US)

(72) Inventors: Matthew D. Fortier, San Jose, CA (US); Max Fahrenkopf, Palo Alto, CA (US)

(21) Appl. No.: 18/694,672

(22) PCT Filed: Aug. 31, 2022
(86) PCT No.: PCT/US22/42123

§ 371 Date: Mar. 22, 2024

Related U.S. Application Data
(60) Provisional application No. 63/247,995, filed on Sep. 24, 2021.

(51) Int. Cl. G05D 1/224; G05D 1/622

(52) U.S. Cl. CPC G05D 1/2245; G05D 1/622

(57) ABSTRACT

Implementations described herein provide systems and methods for controlling mobile device movement. In one implementation, a preference trigger is identified, and a preference representation is generated. Path input is obtained, and a plan is generated.

### CROSS-REFERENCE TO RELATED APPLICATION

The present application claims priority to U.S. Provisional Patent Application No. 63/247,995, filed on Sep. 24, 2021, which is incorporated by reference in its entirety herein.

### FIELD

Aspects of the present disclosure relate to systems and methods for controlling movement of a mobile device and more particularly to substantially real time control of a mobile device through manipulation of a graphical representation of the mobile device.

### BACKGROUND

Motion of mobile devices may be generally controlled in various manners. For example, a mobile device may move along a path from an origin location to a destination location. Multiple possible movement paths may exist along the path.

### SUMMARY

Implementations described and claimed herein provide systems and methods for controlling mobile device movement. In one implementation, a preference trigger associated with a path of a mobile device is identified. A preference representation is presented in accordance with identifying the preference trigger using a display. The preference representation includes a representation of the mobile device presented within a scene context indicative of a current position of the mobile device relative to at least one element of a real world environment in which the mobile device is located. A path input specifying a path preference is obtained. The path input is captured using an input device, and the path preference is specified through a manipulation of the representation of the mobile device. A motion plan for the mobile device reflecting the path preference is generated. The motion plan specifies an action for movement by the mobile device.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is a diagram of an example motion control system for controlling mobile device movement.

FIGS. 2A-2C depict an example preference representation including a representation of a mobile device presented within a scene context.

FIGS. 3A-3C illustrate another example preference representation including a representation of a mobile device presented within a scene context.

FIGS. 4A-4C show another example preference representation including a representation of a mobile device presented within a scene context.

FIGS. 5A-5C show another example preference representation including a representation of a mobile device presented within a scene context.

FIGS. 6A-6C depict another example preference representation including a representation of a mobile device presented within a scene context.

FIGS. 7A-7C illustrate another example preference representation including a representation of a mobile device presented within a scene context.

FIG. 8 illustrates example operations for mobile device movement control.

FIG. 9 illustrates example operations for mobile device movement control.

FIG. 10 is a functional block diagram of an electronic device including operational units arranged to perform various operations of the presently disclosed technology.

FIG. 11 is an example computing system that may implement various aspects of the presently disclosed technology.

### DETAILED DESCRIPTION

Aspects of the presently disclosed technology relate to substantially real time mobile device control through manipulation of a representation of the mobile device. In one aspect, a mobile device is moving along a path, such as a movement path or a travel path, from an origin location to a destination location. At some point corresponding to the path (e.g., along the path, at or near the origin location, at or near the destination location, associated with a deviation from the path, etc.), a preference trigger is identified. The preference trigger may involve an ambiguity associated with the path, where the ambiguity corresponds to a presence of multiple operable paths associated with moving the mobile device. In accordance with identifying the preference trigger, a preference representation is generated and presented. The preference representation includes a representation of the mobile device presented within a scene context representative of a current position of the mobile device within a real world environment in which the mobile device is located. A path input specifying a path preference is obtained. A motion plan for the mobile device reflecting the path preference is generated, with the motion plan specifying an action for movement by the mobile device.

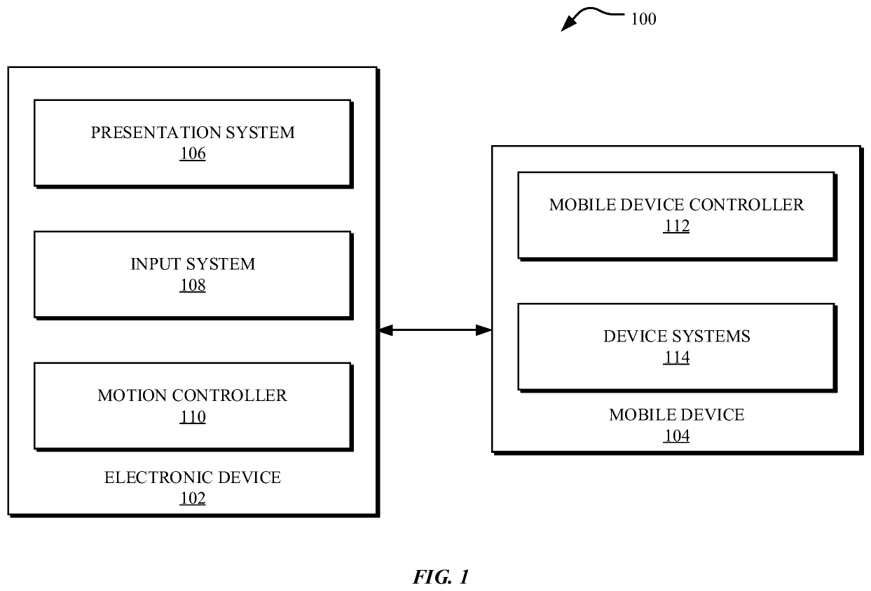

To begin a detailed description of an example system 100 for controlling mobile device movement, reference is made to FIG. 1. The system 100 includes an electronic device 102 and a mobile device 104. In one implementation, the electronic device 102 includes a presentation system 106, an input system 108, and a motion controller 110. The electronic device 102 may be a workstation, smartphone, tablet, wearable, user device, and/or the like. The electronic device 102 may be used to control movement of the mobile device 104.

In one implementation, the mobile device 104 includes a mobile device controller 112 and one or more device systems 114. The mobile device controller 112 controls operation of the mobile device 104, including controlling the various device systems 114, which may include a perception system (e.g., for capturing perception data corresponding to a real world environment in which the mobile device is located 104), a navigation system, a power system, actuators, controls, and/or other devices and systems of the mobile device 104. In one implementation, the electronic device 102 is separate from the mobile device 104. In another implementation, the electronic device 102 may be part of the mobile device 104, with the presentation system 106, the input system 108, and the motion controller 110 integrated into the mobile device 104 for controlling movement of the mobile device 104. The motion controller 110 and the mobile device controller 112 may be separate or integrated systems. Each of the electronic device 102 and the mobile device 104 may optionally include one or more of the presentation system 106, the input system 108, and the motion controller 110 for controlling movement of the mobile device 104.

The input system 108 may include one or more input devices configured to capture various forms of user input. For example, the input system 108 may be configured to capture visual input (e.g., information provided via gesture), audio input (e.g., information provided via voice), tactile input (e.g., information provided via touch, such as via a touch-sensitive display screen (“touchscreen”), etc.), device input (e.g., information provided via one or more input devices), and/or the like from a user. Similarly, the presentation system 106 may include one or more output devices configured to present output data in various forms, including visual (e.g., via display, projection, etc.), audio, and/or tactile. The input system 104 and/or the presentation system 106 may include various software and/or hardware, including augmented reality, virtual reality, for input and presentation. The input system 108 and the presentation system 106 may be integrated into one system, in whole or part, or separate. For example, the input system 108 and the presentation system 106 may be provided in the form of a touchscreen.

The presentation system 106 and the input system 108 generally provide an interactive interface. In one implementation, the interactive interface is deployed in the mobile device 104. For example, the interactive interface may be deployed in an interior of the mobile device 104, thereby facilitating interactions with one or more occupants that may be transported in the mobile device 104. The interactive interface may be provided via an instrument panel, such as interactive dashboard having a touchscreen, a heads-up-display, and/or the like. In another implementation the interactive interface is deployed separately from the mobile device 104 to facilitate interactions with one or more users while being disposed within or outside of the mobile device 104. In one example, the mobile device 104 may determine whether the electronic device 102 is within a threshold distance and if so, permit one or more users to interact with the interactive interface to control movement of the mobile device 104 using the electronic device 102.

The interactive interface may provide a view of a real world environment external to the mobile device 104. The view may be a live direct view through a transparent cover disposed in an opening in the mobile device 104, through a transparent surface of the electronic device 102 or the mobile device 102, and/or the like. The view may alternatively be a live indirect view reproduced using one or more output devices of the presentation system 106. In one implementation, the interactive interface presents the real world environment as a preference representation that is interactive and may be manipulated. Stated differently, the interactive interface may utilize computer-generated graphical objects that represent one or more elements in the real world environment and/or to overlay interactive features or information. In each example, the interactive interface may be used to control movement of the mobile device 104.

The mobile device 104 may be various types of vehicles, robots, and/or machines. In one example, the mobile device 104 is an autonomous vehicle. Autonomous vehicles are capable of operating to move along a travel path with limited user input. Stated differently, rather than the user being operationally engaged to control the actions of the vehicle, the user may provide instructions, such as one or more destination points, and the vehicle transports the user to the selected destination points through a series of autonomous decisions. In one implementation, the mobile device 104 is prepared to move, currently moving, and/or completing a move along a path, such as a movement path or a travel path, from an origin location to a destination location. The movement path may correspond to a movement trajectory or otherwise be associated with a movement task. A travel path may correspond to a route traveling from the origin location to the destination location. At some point corresponding to the path (e.g., along the path, at or near the origin location, at or near the destination location, associated with a deviation from the path, etc.), a preference trigger is identified, for example using the motion controller 110.

A preference representation is generated and presented as an interactive interface in accordance with identifying the preference trigger. In one implementation, the preference representation is generated using the motion controller 110 and presented using the presentation system 106. The preference representation includes a graphical representation of the mobile device 104 presented within a scene context that is indicative of a current position of the mobile device 104 within a real world environment in which the mobile device 104 is located. The representation of the mobile device 104 and the scene context may be simplified representations of the mobile device 104 and at least one element of the real world environment. For example, the representation of the mobile device 104 may be a first graphical object (e.g., icon), which is presented relative to one or more second graphical objects (e.g., icons) representing corresponding elements of the real world environment. Additionally or alternatively, the representations of the mobile device 104 and element(s) of the real world environment include photorealistic features and/or images. The preference representation may include various augmented features, virtual reality features, and/or the like.

The preference representation is presented as an interactive interface for interaction with a user. In accordance with the interaction of the user, a path input specifying a path preference is obtained via the input system 108. For example, the path preference may be specified through a manipulation of the representation of the mobile device 104. The manipulation may include: moving, dragging, swiping, flicking, pulling, pushing, rotating, tapping, and/or the like. The manipulation may be within a two-dimensional (2D) plane or within three-dimensional (3D) space. Further, the manipulation may include moving the mobile device 104 relative to the element(s) represented in the scene context, moving the element(s) relative to the mobile device 104, or some combination thereof. For example, the scene context may remain stationary with the representation of the mobile device 104 being moved within the scene context relative to the element(s). In another example, the representation of the mobile device 104 may remain stationary (e.g., at a central area within the scene context) with the element(s) moving relative to the representation of the mobile device 104.

The path preference may specify a target destination, a target movement, and/or a target operation of the mobile device 104 based on one or more indicated destinations, indicated movements, and/or indicated operations obtained through the manipulation of the representation of the mobile device 104. The motion controller 110 generates a motion plan for the mobile device 104 reflecting the path preference. The motion plan may be communicated from the motion controller 110 to the mobile device controller 112. The motion controller 110 and the mobile device controller 112 may communicate information to each other, including the motion plan, using various wired and/or wireless communication protocols.

The motion plan specifies an action for movement by the mobile device 104. For example, the path preference may include an indicated destination (e.g., an indicated position, indicated orientation, etc.), such that the action of the motion plan is adapted for moving the mobile device towards a destination reflecting the indicated destination. The mobile device controller 112 may generate a target and a trajectory for movement in the real world environment based on the motion plan. The mobile device controller 112 controls the device systems 114 of the mobile device 104 in accordance with the motion plan to move the mobile device 104 along the trajectory based on the target. It will be appreciated that the target may include: a target destination (e.g., target position, target orientation, etc.) that the mobile device 104 moves along the trajectory towards; a target operation (e.g., target speed, target stopping point, target starting point, etc.) that the mobile device 104 moves along the trajectory to reach, and/or the like. For example, the motion plan may include parking, lateral motion (e.g., the mobile device 104 being generally oriented towards a first direction while moving laterally along a second direction that is substantially transverse to the first direction), changing position, avoiding an obstacle, turning, stopping, reducing speed, increasing speed, starting movement (e.g., following a stop at an intersection, at a beginning of a route, etc.), choreographed movement, and/or the like. The action may include various operation(s) associated with moving the mobile device 104 in accordance with executing the motion plan. The mobile device controller 112 may autonomously control the mobile device 104, including one or more of the device systems 114, based on the motion plan.

The preference trigger may be identified based on data captured by the electronic device 102 and/or the mobile device 104. For example, the preference trigger may be identified based on: perception data corresponding to a field of view of the mobile device 104; device status information corresponding to an operational status of or otherwise regarding one or more of the device systems 114; user input obtained via the input system 108, detection of an operation mode transition of the mobile device 104 (e.g., storage mode, navigation mode, responder mode, etc.); navigation information corresponding to routing, traffic, environmental conditions, etc. obtained from a remote source, such as another mobile device, a server, over a network, and/or the like. The preference trigger may correspond to a presence of an ambiguity, a movement command, detection of an operation mode transition, and/or other situations where requested movement tasks, destination control, choreographed motion, and/or the like arise.

The preference trigger involving an ambiguity along the travel path may be identified using the perception data, navigation information, and/or the like. Generally, the ambiguity corresponds to scenarios in which there may be multiple solutions for a movement task, such that the motion controller 112 seeks user input for a preference or user disambiguation associated with selecting one of the solutions for execution. In one implementation, the ambiguity corresponds to a presence of multiple operable paths associated with moving the mobile device 104. For example, an obstacle may be present along a portion of the path where multiple operable paths are present for moving the mobile device 104 around the obstacle (e.g., around the obstacle and towards a destination location).

In one example, the mobile device 104 may be a vehicle may be parked in a garage. As the mobile device 104 is prepared to move or begins moving from the garage autonomously, an obstacle may be detected in a driveway behind the mobile device 104. The obstacle may be detected using a perception system of the mobile device 104. There may be multiple available operable paths around the obstacle towards the street. The motion controller 110 generates the preference representation for interaction with a user to disambiguate the available operable paths or to otherwise indicate a preference for moving around the obstacle. The preference representation includes a representation of the mobile device 104 within a scene context representative of the current position and in some cases a current orientation of the mobile device 104 within the real world environment. For example, the representation of the mobile device 104 may be presented within the scene context relative to at least one element of the real world environment, such as the obstacle, the garage, and/or the street.

During interaction with the interactive interface, the user specifies a path preference for moving the mobile device 104 around the obstacle towards the street. Path input specifying the path preference is captured using the input system 108. In one implementation, the path preference is specified through a manipulation of the representation of the mobile device 104. For example, the manipulation may include moving the representation of the mobile device 104 from a current position to an indicated position within the scene context for moving around the obstacle, such as to the left or to the right of the obstacle.

The motion controller 110 generates a motion plan specifying a target movement for moving the mobile device 104 around the obstacle towards the destination reflecting the path preference. Based on the motion plan, the mobile device controller 112 generates a target and a trajectory for moving the mobile device 104 around the obstacle in the real world environment and controls the device systems 114 in autonomously moving the mobile device 104 accordingly. In this example, a user may control the mobile device 104 from an interior or outside of the mobile device 104 to disambiguate ambiguities, specify preferred movements, move around obstacles, and/or otherwise move the mobile device 104. For example, the user may initiate autonomous movement of the mobile device 104 out of the garage and address an obstacle along the path from either inside or outside of the mobile device 104 using the electronic device 102.

The preference trigger may be identified based on a movement command. The movement command may be obtained based on: user input captured with the input system 108, a remote command over a network (e.g., from a server, another authorized mobile device, another authorized electronic device, a remote operator, etc.), data obtained by the mobile device controller 112 (e.g., based on data from one or more of the device systems 114, etc.), and/or the like. The user input may specify a desired movement task via the interactive interface. The remote command may specify a movement task in accordance with maintenance, software updates, emergencies, navigation, parental supervision, and/or other issues. For example, the remote command may specify a movement task corresponding to an issue, such as pull over to a safe location, reduce speed, etc. The data obtained by the mobile device controller 112 may specify a movement task associated with a device condition of the mobile device 104. For example, the data obtained by the mobile device controller 112 may indicate that a fuel or power charge is low, and the movement task may be associated with addressing the low fuel or power charge. The movement command generally specifies one or more movement tasks, including but not limited to, parking (e.g., close quarter parking), changing lanes, changing position, changing orientation, changing a trajectory (e.g., to avoid an obstacle), turning, stopping, pulling over, reducing speed, increasing speed, starting (e.g., initiating movement from a stopped position), choreographed movement (e.g., three point turn, etc.), and/or the like. Other movement commands specifying movement tasks are contemplated.

In one example, the mobile device 104 may be traveling along a travel path in a lane. The mobile device 104 may be navigating along the travel path associated with a route from an origin to a destination autonomously. As the mobile device 104 is traveling in the lane along the travel path, the interactive interface may be presented using the presentation system 106. In one implementation, the interactive interface includes the preference representation presented in substantially real time as the mobile device 104 navigates along the travel path. The preference representation includes a representation of the mobile device 104 within a scene context representative of the current position and in some cases a current orientation of the mobile device 104 within the real world environment. For example, the representation of the mobile device 104 may be presented within the scene context relative to at least one element of the real world environment, such as lane markers of the lane. As the mobile device 104 navigates along the travel path, the preference representation may include a representation of a current movement of the mobile device 104. For example, the movement may be represented by an animation of the lane markers and/or the mobile device 104 in the scene context. The animation may include a movement of the lane markers and/or the mobile device 104 relative to each other and proportional to a speed of the mobile device 104. A user may interact with the interactive interface to provide a movement command specifying a movement task.

The motion controller 112 identifies a preference trigger based on the movement command and presents the preference representation in accordance with the preference trigger. For example, where the preference representation is presented in substantially real time as the mobile device 104 moves along the travel path, the preference representation may be presented for interaction to capture the movement command(s), modified in response to the movement command (e.g., representation of one or more additional elements may be added to or deleted from the scene context), and/or the like. The movement command may provide or otherwise be associated with path input specifying a path preference associated with the movement task.

During interaction with the interactive interface, the user specifies the path preference corresponding to the movement command for executing a movement task. For example, where the movement command includes the user input, the user input may include path input specifying the path preference. In another example, such as where the movement command includes a remote command or data obtained by the mobile device controller 112, the movement command may prompt the user for path input regarding a path preference for the movement task. Path input specifying the path preference is captured using the input system 108. In one implementation, the path preference is specified through a manipulation of the representation of the mobile device 104. For example, the manipulation may include moving the representation of the mobile device 104 from a current position to an indicated position within the scene context relative to the lane markers to specify a path preference representative of changing lanes from the lane associated with the travel path to a second lane. As another example, the manipulation may include pushing or pulling the representation of the mobile device 104 within the scene context relative to the lane markers to specify a path preference representative of increasing speed or reducing speed of the mobile device 104. As another example, the manipulation may include moving and/or rotating the representation of the mobile device 104 from a current position and/or current orientation to an indicated position and/or indicated orientation to specify a path preference representative of a choreographed movement (e.g., three point turn, etc.). The manipulation may specify a path preference reflective of other movement tasks, such as parking, changing position, changing orientation, changing a trajectory (e.g., to avoid an obstacle), turning, stopping, pulling over, starting (e.g., initiating movement from a stopped position), and/or the like. In one example, the movement command may be used to override a current movement task of the mobile device 104. Feedback (e.g., haptic feedback, visual feedback, audio feedback, etc.) may be presented in response to a movement command overriding a current movement task.

The motion controller 110 generates a motion plan specifying a target movement for operating the mobile device 104 reflecting the movement task of the path preference. Based on the motion plan, the mobile device controller 112 generates a target and a trajectory for executing the movement task in the real world environment and controls the device systems 114 in autonomously moving the mobile device 104 accordingly. The target and trajectory may include one or more sub-targets and/or sub-trajectories based on a complexity of the movement task. For example, some choreographed movements may include a series of sub-trajectories and a series of sub-targets, such as multiple stopping points in a three-point turn.

The preference trigger may be identified based on a detection of an operation mode of the mobile device 104. The operation mode may include, without limitation, a storage mode, a navigation mode, a responder mode, and/or the like. The operation mode may be detected based on an automatic or manual transition into the operation mode, a command initiating the operation mode, detection of a condition associated with the operation mode, and/or the like.

The preference trigger may be identified based on a transition into a storage mode (e.g., following an exit of occupants from an interior), a command initiating the storage mode (e.g., selection of a parking option), detection of a condition associated with the storage mode (e.g., detection of an arrival at a destination location), and/or the like. It will be appreciated that storage associated with the storage mode generally corresponds to the mobile device 104 being parked, housed, disposed in a waiting area, or otherwise stored for varying lengths of time. Further in connection with the preference trigger, in one example, there may be multiple available parking locations. The motion controller 110 generates the preference representation for interaction with a user to disambiguate the available parking locations or to otherwise indicate a preference for moving into a parking location. The preference representation includes a representation of the mobile device 104 within a scene context representative of the current position and optionally a current orientation of the mobile device 104 within the real world environment. For example, the representation of the mobile device 104 may be presented within the scene context relative to at least one element of the real world environment, such as available positions in a garage. The mobile device 104 may detect one or more available parking locations using perception data obtained by the mobile device 104, parking data obtained from a parking map database or a remote source, and/or the like.

During interaction with the interactive interface, the user specifies a path preference for moving the mobile device 104 into one of the available parking locations. In one example, the path preference may specify movement into a close quarters parking location with one or more surfaces, such as those of other mobile devices, walls, or other structures, in close proximity to the parking location. Path input specifying the path preference is captured using the input system 108. In one implementation, the path preference is specified through a manipulation of the representation of the mobile device 104. For example, the manipulation may include moving the representation of the mobile device 104 from a current position to an indicated position within the scene context for moving the mobile device 104 into a parking location.

The motion controller 110 generates a motion plan specifying a target movement for moving the mobile device 104 into the parking location reflecting the path preference. Based on the motion plan, the mobile device controller 112 generates a target and a trajectory for moving the mobile device 104 into the parking location in the real world environment and autonomously controls the device systems 114 in moving the vehicle accordingly. The target and the trajectory may include a series of sub-targets and sub-trajectories, for example, where the parking location is a close quarters parking location. In this example, a user may control the mobile device 104 from an interior or outside the mobile device 104 to move the vehicle into a parking location. The user may initiate the storage mode to park the mobile device 104 from outside of an interior of the mobile device 104 using the electronic device 102.

In another example, the storage mode may be associated with detection of a kiosk associated with the electronic device 102 for controlling movement of a plurality of mobile devices, including the mobile device 104, relative to one or more locations. For example, the plurality of mobile devices may be moved from the kiosk to a parking location, between parking locations, and from the parking location to the kiosk. The mobile device 104 may be moved sequentially and/or in parallel. The motion controller 110 generates the preference representation for interaction with a user, such as an operator of the kiosk, to indicate a preference for moving at least one of the plurality of mobile devices. The preference representation includes a representation of the plurality of mobile devices within a scene context representative of the current positions and optionally a current orientations of the plurality of mobile devices within the real world environment, for example relative to at least one element of the real world environment, such as one or more parking locations, each other, and/or the kiosk.

During interaction with the interactive interface, the user specifies a path preference for moving the plurality of mobile devices, sequentially or in parallel. Path input specifying the path preference is captured using the input system 108. In one implementation, the path preference is specified through a manipulation of the representations of the plurality of mobile devices. The motion controller 110 generates a motion plan specifying a target movement for moving each of the mobile devices reflecting the path preference. Based on the motion plan for at least one of the mobile devices, the mobile device controller 112 generates a target and a trajectory for moving at least one of the mobile devices in the real world environment and controls the device systems 114 accordingly. For example, the user may control valeting of the mobile devices autonomously using the electronic device 102, which may be located, for example, at the kiosk.

In another example, the preference trigger may be identified based on a detection of an responder mode. The responder mode may be detected based on a transition into a responder mode (e.g., based on detection of a nearby first responder device), a command initiating the responder mode (e.g., a command received by the mobile device 104 or the electronic device 102, a command from a first responder device, etc.), detection of a condition associated with the responder mode (e.g., based on data obtained from device systems of the first responder device, a maintenance issue associated with the mobile device 104, etc.), and/or the like. The mobile device 104 may autonomously move or otherwise operate based on a condition associated with the responder mode (e.g., pull over, trigger hazard signals, move to a safe location to stop, initiate a communication, etc.).

In connection with the responder mode, a plurality of mobile devices, including the mobile device 104, may be moved. For example, at least one mobile device may be moved to provide space for a first responder device to pass. The mobile devices may be moved sequentially and/or in parallel. In another example, the mobile device 104 may be moved to stop at a safe location for addressing a condition (e.g., a maintenance issue) associated with the responder mode. The motion controller 110 generates the preference representation for interaction with a user, such a first responder, to indicate a preference for moving the one or more mobile devices. The preference representation includes a representation of at least one of the plurality of mobile device within a scene context representative of the current position and optionally current orientation of the mobile devices within the real world environment. For example, the representation of at least one of the plurality of mobile devices may be presented within the scene context relative to at least one element of the real world environment, such as lane markers, shoulders or other areas off of and alongside a road, an incident site, and/or the like.

During interaction with the interactive interface, the user specifies a path preference for moving the plurality of mobile devices into a destination location as necessary in accordance with the condition corresponding to the response mode. Path input specifying the path preference is captured using the input system 108. In one implementation, the path preference is specified through a manipulation of the representation of the mobile devices. The motion controller 110 generates a motion plan specifying a target movement for moving each of the mobile devices reflecting the path preference. Based on the motion plan for one of the mobile devices, the mobile device controller 112 generates a target and a trajectory for moving the corresponding mobile device in the real world environment and controls the device systems 114 accordingly.

It will be appreciated that the presently disclosed technology may be used in a variety of contexts for controlling movement of the mobile device 104 using the interactive interface, including through manipulation of the representation of the mobile device 104 via the preference representation. In one implementation, the manipulation of the representation of the mobile device 104 includes moving the representation of the mobile device 104 to an indicated destination, which may include an indicated position and optionally an indicated orientation within the scene context.

The manipulation of the representation of the mobile device 104 may be in 2D space. In one implementation, the manipulation of the representation of the mobile device 104 in 2D space may include moving the representation of the mobile device 104 along a plane (e.g., an x-y plane) to an indicated position within the scene context. For example, the representation of the mobile device 104 may be moved in an x-direction and/or a y-direction from a current position to the indicated position. The manipulation of the representation of the mobile device 104 may similarly include rotating the representation of the mobile device 104 within the plane to an indicated orientation within the scene context. The plane may correspond to a touchscreen of the presentation system 108 and/or the input system 106. The manipulation of the representation of the mobile device 104 may be in 3D space, with the representation of the mobile device 104 being moved within a volume corresponding to the scene context. The manipulation of the representation of the mobile device 104 may be tactile-based, visual-based, audio-based, and/or device-based.

In one implementation, the manipulation of the representation of the mobile device 104 includes three degrees of freedom. For example, manipulation within two degrees of freedom provides the ability to control a position of the representation of the mobile device 104. The position may be moved along a first direction (e.g., x-direction) and/or a second direction (e.g., y-direction). Manipulation within a third degree of freedom provides the ability to control an orientation of the representation of the mobile device 104 (e.g., heading, tilting, etc.). The manipulation specifies a path preference, and the motion controller 112 generates a motion plan for the mobile device 104 reflecting the path preference. The motion plan specifies an action for movement by the mobile device 104. The action may correspond to a target and a trajectory for a movement task.

The motion plan may be obtained by the mobile device controller 112, which generates the target and the trajectory of the mobile device 104 in the real world environment based on the motion plan. In one implementation, the mobile device controller 112 generates costs, targets, and constraints for a sequence of optimization problems to execute the motion plan using subtasks. The mobile device controller 112 solves a constrained optimization problem to generate a smooth trajectory for the subtasks and the device systems 114 are controlled to track the trajectory, for example in accordance with a velocity profile and a steering angle. The mobile device 104 may autonomously move along the trajectory towards the target.

Generally, the presently disclosed technology provides a light weight interaction model in the form of an interactive interface with a preference representation to control movement of the mobile device 104, for example using a touch interface. The interactive interface may facilitate control of complex movement tasks. For example, complex vehicle movements typically involve extensive steering, gearing, and/or pedal inputs. The presentation system 106 and the input system 108 provide an interactive interface that reduces extraneous information, as well as the inputs for navigating the mobile device 104. Using one or more simple gestures or other types of user-friendly manipulations of features of the interactive interface, such as the representation of the mobile device 104, a user may easily control movement of the mobile device 104, including precision control of complex movements, destination, and operation, in substantially real time. In one example, the interactive interface permits small adjustments and micro-targets during movement to execute complex movement tasks.

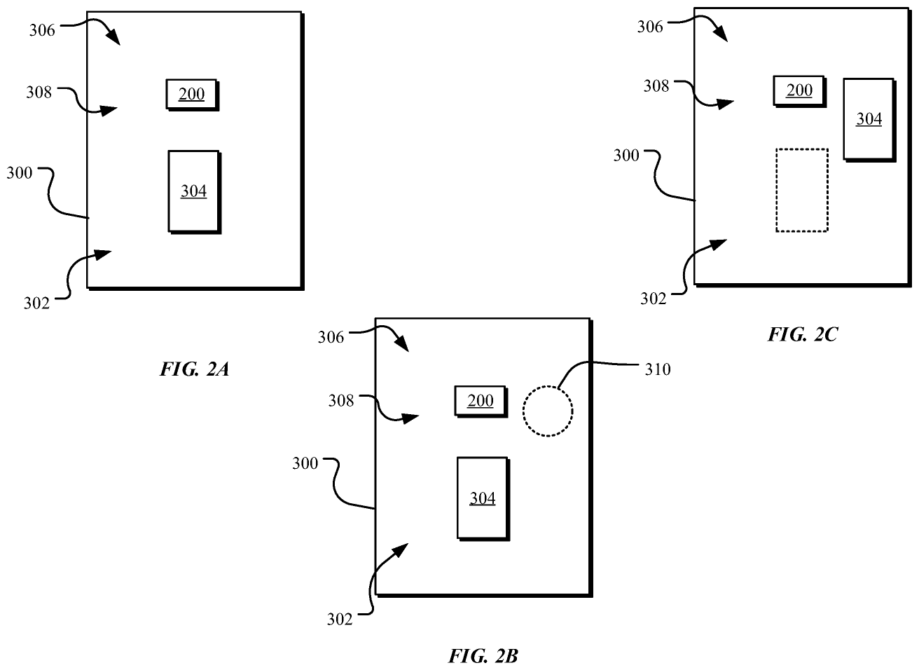

The presentation system 106 and the input system 108 may be in various forms, as described herein, to provide the interactive interface. As one example, the presentation system 106 and the input system 108 are provided in the form of a touchscreen 300, as shown FIGS. 2A-7C. The touchscreen 300 may be part of the electronic device 102 for controlling the mobile device 104 from various locations, including, without limitation, an interior of the mobile device 104, exterior to the mobile device 104, and/or remotely. The mobile device controller 112 may restrict control of the mobile device 104 to authorized electronic devices, electronic devices located within a geometric fence of the mobile device 104, electronic devices connected via secure communication, and/or a combination thereof. The touchscreen 300 may be part of the mobile device 104, as described herein, for example as a dashboard. The touchscreen 300 provides an interactive interface including a preference representation 302 for controlling movement of the mobile device 104.

In one implementation, the preference representation 302 includes a representation 304 of the mobile device 104 presented within a scene context 306. The scene context 306 is representative of a current position and optionally a current orientation of the mobile device 104 relative to at least one element 308 of a real world environment in which the mobile device 104 is located. Exemplary element(s) 308 may include, without limitation, lane markers, parking location(s), other mobile device(s), obstacle(s), external object(s), and/or the like. Each element of the real world environment may be presented as a corresponding element representation 308 in the scene context 306. The element representation 308 may include a graphical object, photorealistic features, an image, and/or the like. In one example, the element representations 308 of the various elements of the real world environment and the representation 304 of the mobile device 104 are graphical objects in the form of icons. Such icon-based representations simplify the information shown to the user by eliminating extraneous detail and elements.

As described herein, a user may interact with the interactive interface and control movement of the mobile device 104 by manipulating the representation 304 of the mobile device 104. In one implementation, one or more gestures may be used to manipulate the representation 304 of the mobile device 104 in three degrees of freedom within the scene context 306. The one or more gestures may include one or more touch points on the touchscreen 300. However, other gestures and path inputs are contemplated as detailed herein. In one example, a first gesture (e.g., a first touch point) may control a first degree of freedom (e.g., x-direction) and a second degree of freedom (e.g., y-direction) of the representation 304 of the mobile device 104, and a second gesture (e.g., a second touch point) controls a third degree of freedom (e.g., heading or other orientation) of the representation 304 of the mobile device 104.

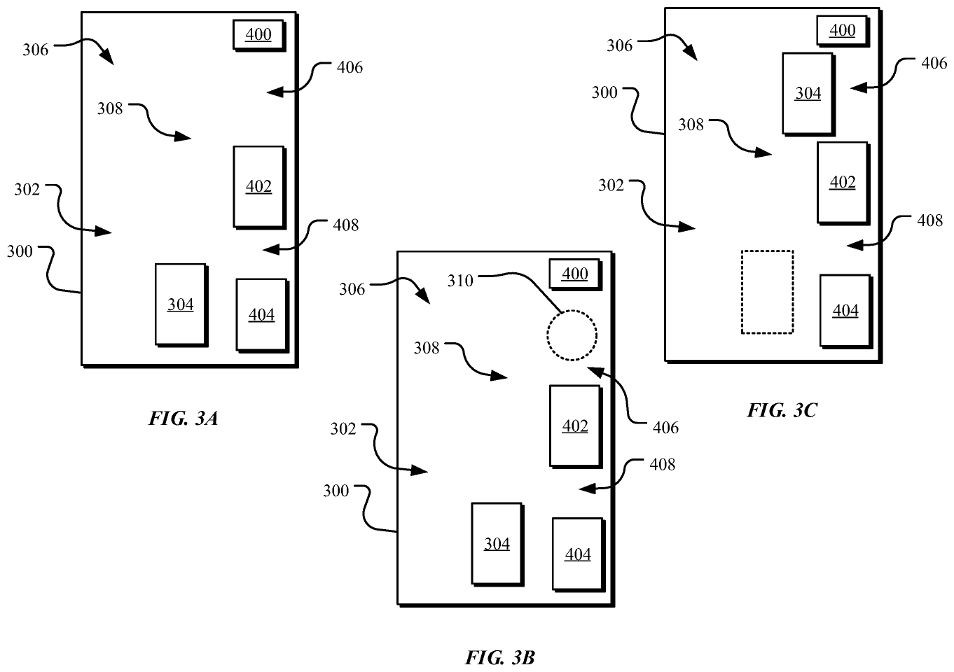

FIGS. 3A-3C illustrate an example path preference for a position control operation specified through a manipulation of the representation 304 of the mobile device 104. The user may specify a path preference through a manipulation of the representation 304 of the mobile device 104 to specify a path preference for moving the mobile device 104 from a current location to the indicated destination. The indicated destination may specify a path from multiple available operable paths for the mobile device 104 to move towards a destination.

For example, an obstacle may be detected along a path of the mobile device 104, with the element representations 308 of the scene context 306 including an obstacle representation 200. A user may interact with the interactive interface to control movement of the mobile device 104 by manipulating the representation 304 of the mobile device 104. The manipulation of the representation 304 of the mobile device 104 may specify the indicated destination as a direction for the mobile device 104 to move around the obstacle towards a destination of the path. The manipulation may include a first touch point 310 starting at the current location of the representation 304 and moving the representation 304 of the mobile device 104 in two degrees of freedom to the indicated destination for moving around the obstacle representation 200. The indicated destination may be specified, in one example, by maintaining the first touch point 310 through dragging until the indicated destination is reached and the first touch point 310 is released.

A motion plan for the mobile device 104 reflecting the path preference is generated. The motion plan may specify various actions for movement by the mobile device 104 to move around the obstacle in the real world environment reflected by the obstacle representation 200 towards the target destination. The preference representation 302 may present a representation of the path preference though a movement of the representation 304 of the mobile device 104 from the current position to the indicated destination and around the obstacle representation 200 within the scene context 306. Such a representation of the path preference may be presented as an animation of one or more icons within the scene context 306. For example, the representation 304 of the mobile device 104 may move within the scene context 306 to the indicated destination and around the obstacle representation 200 with other representations remaining stationary, the obstacle representation 200 may move within the scene context 306 with the representation 304 of the mobile device 104 remaining stationary, or some combination thereof. The actions of the motion plan may involve movements that are different than the representation of the path preference of the preference representation 302, such that the preference representation 304 is a simplified representation of movement to capture a path preference for autonomous execution by the mobile device 104.

Turning to FIGS. 3A-3C, an example path preference for a storage operation specified through a manipulation of the representation 304 of the mobile device 104 is illustrated. The scene context 306 is representative of a current position of the mobile device 104 relative to element representations 308 corresponding to elements of the real world environment in which the mobile device 104 is located. The element representations 308 include a first element representation 400, a second element representation 402, and a third element representation 404. The element representations 400-404 may correspond to objects with a parking location represented as openings 406 and 408 disposed between them. For example, the objects may be vehicles parallel parked with an open parking location between them for parallel parking by the mobile device 104.

The user may specify a path preference for selection of one the openings 406 and 408 through a manipulation of the representation 304 of the mobile device 104 to specify a path preference for moving the mobile device 104. For example, the manipulation may include the first touch point 310 moving the representation 304 of the mobile device 104 in two degrees of freedom (along an x-axis and a y-axis or otherwise along first and second directions) to an indicated destination in the opening 406 between the first and second element representations 400 and 402. The indicated destination may be specified, in one example, by maintaining the first touch point 310 through dragging until the indicated destination is reached and the first touch point 310 is released.

A motion plan for the mobile device 104 reflecting the path preference is generated. The motion plan may specify various actions for movement by the mobile device 104 to move into the target destination in the real world environment reflected by the opening 406. The preference representation 302 may present a representation of the path preference though a movement of the representation 304 of the mobile device 104 from the current position to the indicated destination within the scene context 306. Such a representation of the path preference may be presented as an animation of one or more icons within the scene context 306. For example, the representation 304 of the mobile device 104 may move within the scene context 306 to the indicated destination with other representations remaining stationary, the element representations 400-404 may move within the scene context 306 with the representation 304 of the mobile device 104 remaining stationary, or some combination thereof. The actions of the motion plan may involve movements that are different than the representation of the path preference of the preference representation 302, such that the preference representation 304 is a simplified representation of movement, as detailed herein.

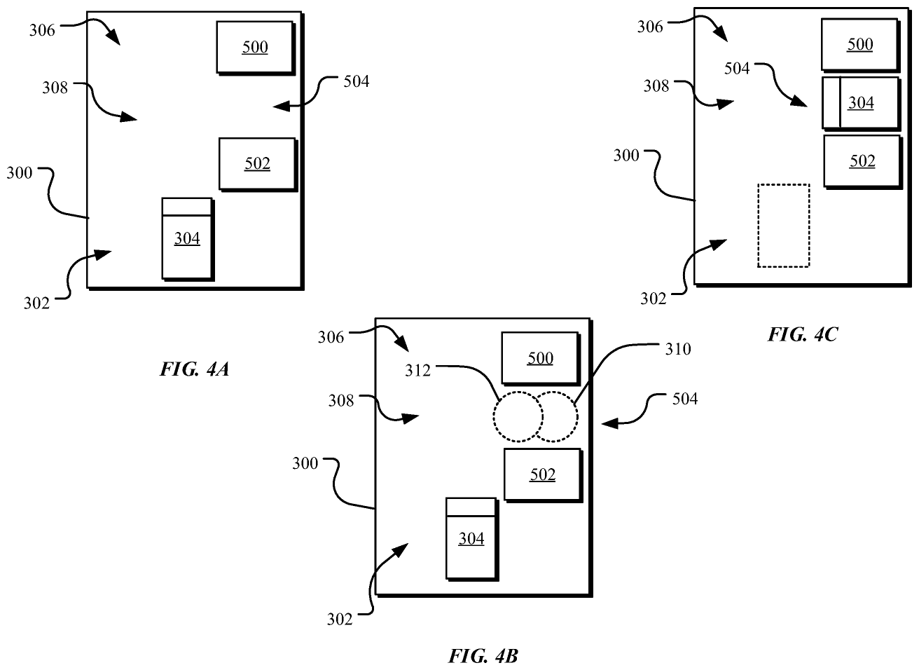

In one implementation, a storage operation may involve close quarters parking, as illustrated in FIGS. 4A-4C. Moving within close quarters may involve various situations in which the mobile device 104 is moving along a trajectory and/or to a target that has one or more surfaces in close proximity to the mobile device 104. For example, the mobile device 104 may be directed to move along a trajectory to a target destination, such as a parking location, between a first object and a second object. Typically, executing such a movement task would involve extensive user input, as detailed herein, and once the mobile device 104 is positioned in the target destination between the objects, any occupants within the mobile device 104 may not be able to exit due to the close proximity of the objects. As such, a user may control movement of the mobile device 104 using the preference representation 302, such that the occupants may exit the mobile device 104 prior to the mobile device 104 being moved to the target destination.

The storage operation may be specified through a manipulation in three degrees of freedom. The scene context 306 is representative of a current position of the mobile device 104 relative to the element representations 308. The element representations 308 include a first element representation 500 and a second element representation 502. In this example, the first and second element representations 500 and 502 may correspond to two objects with the target destination location represented as an opening 504 disposed between them. For example, the two objects may be two vehicles parked in narrow parking spaces with an open parking space between them for close quarters parking by the mobile device 104.

The user may specify a path preference through a manipulation of the representation 304 of the mobile device 104 relative to the first and second element representations 500 and 502 and the opening 504 to specify a path preference for moving the mobile device 104 to the target destination. For example, the manipulation may include the first touch point 310 and a second touch point 312 moving the representation 304 of the mobile device 104 in three degrees of freedom to an indicated destination, including an indicated position and an indicated orientation, in the opening 504 between the first and second element representations 500 and 502. The manipulation within the three degrees of freedom includes moving the representation 304 of the mobile device 104 along an x-direction and a y-direction and rotating a heading of the representation 304 of the mobile device 104. The indicated destination, including the indicated position and the indicated orientation, may be specified, in one example, by maintaining the first touch point 310 and the second touch point 312 through dragging and rotation of the representation 304 of the mobile device 104 until the indicated destination in the opening 504 is reached and the first touch point 310 and the second touch point 312 are released.

A motion plan for the mobile device 104 reflecting the path preference is generated. The motion plan may specify various actions for movement by the mobile device 104 to move into the target destination in the real world environment reflected by the opening 504. The preference representation 302 may present a representation of the path preference though a movement of the representation 304 of the mobile device 104 from the current position to the indicated destination in the opening 504 within the scene context 306. Such a representation of the path preference may be presented as an animation of one or more icons within the scene context 306. For example, the representation 304 of the mobile device 104 may move within the scene context 306 to the indicated destination in the opening 504 with other representations remaining stationary, the first and second element representations 500 and 502 may move within the scene context 306 with the representation 304 of the mobile device 104 remaining stationary, or some combination thereof. The actions of the motion plan may involve movements that are different than the representation of the path preference of the preference representation 302, such that the preference representation 304 is a simplified representation of movement to capture a path preference for execution by the mobile device controller 112.

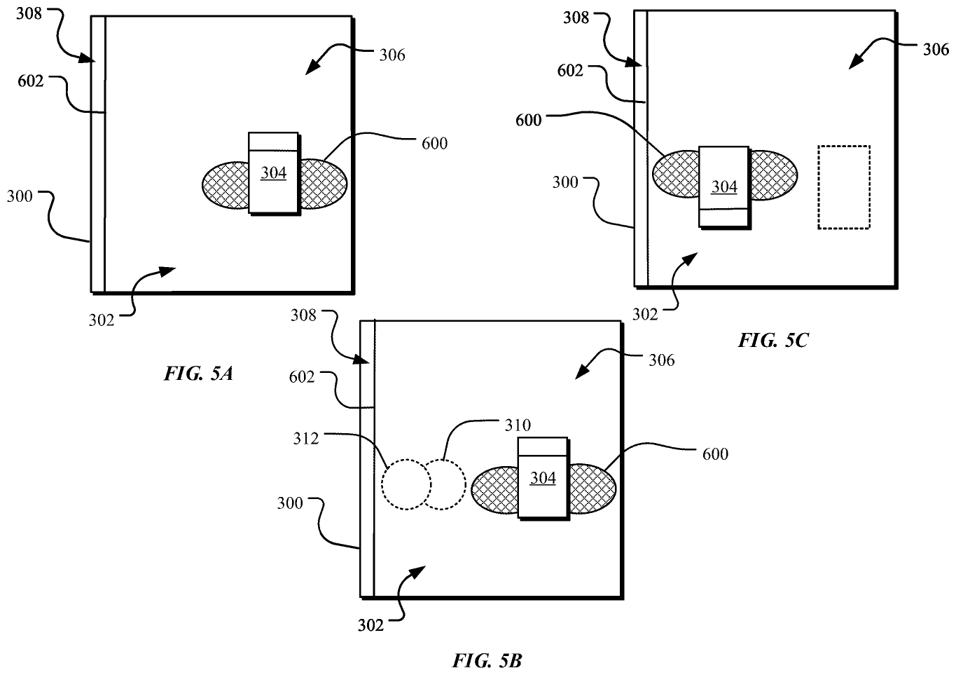

In one implementation, the scene context 306 furthers include a representation 600 of kinematic limits of available movements of the mobile device 104 from the current location. For example, as illustrated in FIGS. 5A-5C, an example path preference for a turning operation may be specified through a manipulation of the representation 304 of the mobile device 104. The scene context 306 is representative of a current position of the mobile device 104 relative to the element representations 308. The element representations 308 may include a boundary 602 representative of a limit of space available in the real world environment for executing the turn. The limit may be defined based on a lane marker, a curb, a wall, a barrier, objects, surfaces, and/or the like.

The user may specify a path preference for the turning operation through a manipulation of the representation 304 of the mobile device 104 in three degrees of freedom. For example, the manipulation may include the first touch point 310 and the second touch point 312 moving the representation 304 of the mobile device 104 in three degrees of freedom to an indicated destination completing a turn of the mobile device 104. The manipulation within the three degrees of freedom includes moving the representation 304 of the mobile device along an x-direction and a y-direction and rotating a heading of the representation 304 of the mobile device 104 to represent the turn. The indicated destination, including an indicated position and an indicated orientation, may be specified, in one example, by maintaining the first touch point 310 and the second touch point 312 through dragging and rotation of the representation 304 of the mobile device 104 until the indicated destination corresponding to the turn is reached and the first touch point 310 and the second touch point 312 are released.

The manner in which the mobile device 104 executes the turn in the real world environment is based on the kinematic limits of the mobile device 104. A motion plan for the mobile device 104 reflecting the path preference for the turn is generated. The motion plan may specify various actions for movement by the mobile device 104 to execute the turn in the real world environment. For example, depending on the kinematic limits of the mobile device 104 relative to the limit of space represented by the boundary 602, the mobile device 104 may execute a particular turn type, such as a U-turn, a three-point turn, and/or the like, to reach the target destination corresponding to the turn. The preference representation 302 may present a representation of the path preference though a movement of the representation 304 of the mobile device 104 from the current position to the indicated destination corresponding to execution of the turn within the scene context 306. Such a representation of the path preference may be presented as an animation of one or more icons within the scene context 306. Further, the representation 600 of the kinematic limits of the mobile device 104 may be presented relative to the boundary 600 to indicate the particular turn type. For example, if the representation 600 of the kinematic limits of the mobile device 104 overlap or intersect the boundary 602 when representation 304 of the mobile device 104 reaches the indicated destination, the mobile device 104 may executed a three-point turn. Otherwise, if the representation 600 of the kinematic limits of the mobile device 104 is not overlapping or intersecting the boundary 602 when representation 304 of the mobile device 104 reaches the indicated destination, as illustrated in FIG. 5C, the mobile device 104 may executed a U-turn. The actions of the motion plan may involve movements that are different than the representation of the path preference of the preference representation 302, such that the preference representation 304 is a simplified representation of movement to capture a path preference.

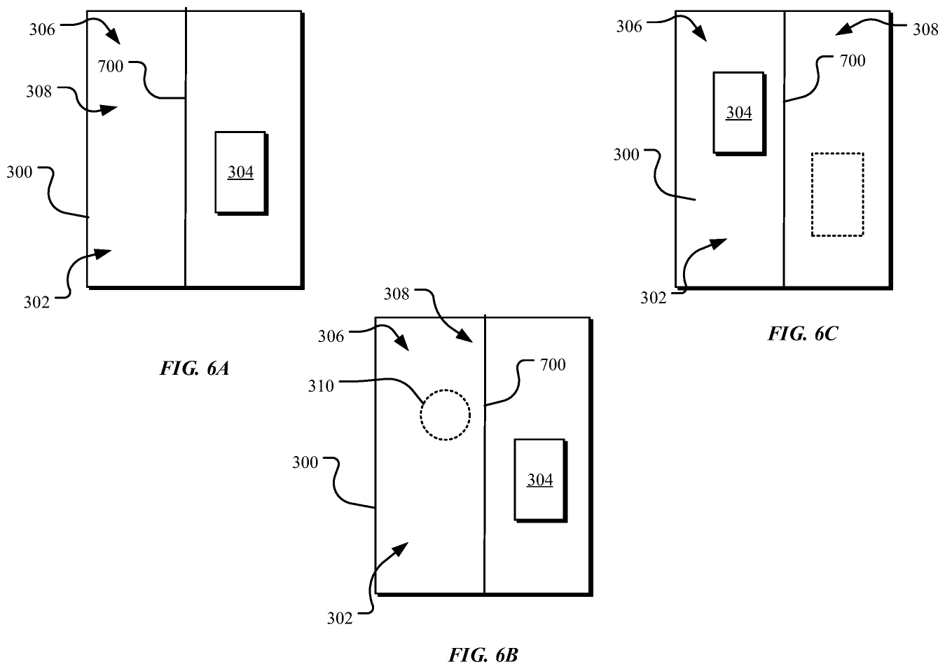

In one implementation, a user may control a position change of the mobile device 104 through simple interaction with the preference representation 302. In this manner, the user may specify a path preference by designating an indicated destination at a position or moving along a position (e.g., along a line) that is different from a current position that the mobile device 104 is at and/or traveling along. For example, FIGS. 6A-6C illustrate an example path preference for a position change operation, such as a lane change operation, specified through a manipulation of the representation 304 of the mobile device 104. The scene context 306 is representative of a current position of the mobile device 104 relative to the element representations 308. The element representations 308 include a first lane representation and a second lane representation separated by a lane marker representation 700.

The user may specify a path preference through a manipulation of the representation 304 of the mobile device 104 to specify a path preference for moving the mobile device 104 from a current location in the first lane representation to an indicated destination in the second lane representation. The manipulation may include the first touch point 310 starting at the current location of the representation 304 in the first lane representation and moving the representation 304 of the mobile device 104 in two degrees of freedom to the indicated destination in the second lane representation for moving along. The indicated destination may be specified, in one example, by maintaining the first touch point 310 from the first lane representation through dragging until the indicated destination is reached in the second lane representation and the first touch point 310 is released.

A motion plan for the mobile device 104 reflecting the path preference is generated. The motion plan may specify various actions for movement by the mobile device 104 to change lanes in the real world environment reflected by the first lane representation and the second lane representation. The preference representation 302 may present a representation of the path preference though a movement of the representation 304 of the mobile device 104 from the current position in the first lane representation to the indicated destination in the second lane representation within the scene context 306. Such a representation of the path preference may be presented as an animation of one or more icons within the scene context 306. For example, the representation 304 of the mobile device 104 may move within the scene context 306 to the indicated destination in the second lane representation with other representations remaining stationary, the lane representations may move within the scene context 306 with the representation 304 of the mobile device 104 remaining stationary, or some combination thereof. The actions of the motion plan may involve movements that are different than the representation of the path preference of the preference representation 302, such that the preference representation 304 is a simplified representation of movement to capture a path preference for moving from the first lane to the second lane while continuing along a heading.

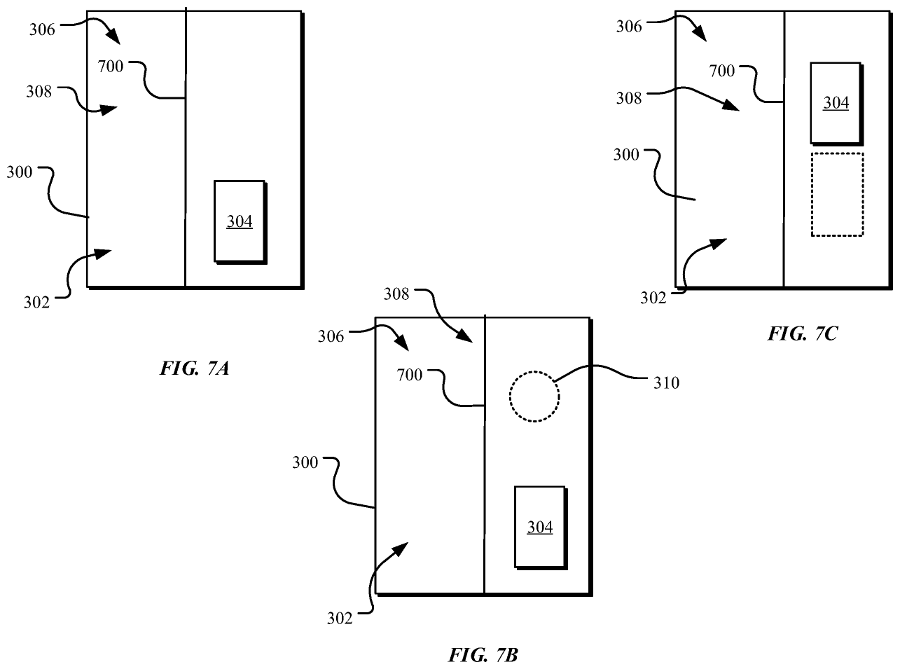

Referring to FIGS. 7A-7C, an example path preference for a speed change operation and/or a state change operation specified through a manipulation of the representation 304 of the mobile device 104 is shown. The scene context 306 is representative of a current position of the mobile device 104 relative to the element representations 308, such as the lane marker 700. In one example, the lane marker 700 is animated, such that the lane marker 700 moves within the scene context 306 proportional to a speed at which the mobile device 104 is moving. The user may specify a path preference for a speed change operation (e.g., a speed increase or decrease) and/or a state change operation (e.g., starting, stopping, etc.) through a manipulation of the representation 304 of the mobile device 104.

The manipulation may include the first touch point 310 starting at the current location of the representation 304 and moving the representation 304 of the mobile device 104 in one degree of freedom to the indicated destination representative of a speed change. For example, a forward movement to the indicated destination may represent a speed increase and a backward movement to the indicated destination may represent a speed decrease. The indicated destination may be specified, in one example, by maintaining the first touch point 310 from the current location through dragging until the indicated destination is reached and the first touch point 310 is released. A distance between the current location and the indicated destination may be used to indicate a proportion of the speed change. For example, a larger distance may indicate a larger change in speed. A state change operation may be indicated based on a degree of touch force of the first touch point 310. For example, if the degree of touch force applied to the touchscreen 300 in connection with the first touch point 310 exceeds a touch threshold, a starting operation or a stopping operation may be indicated as the path preference depending on a current operation state of the mobile device 104 (e.g., currently stationary versus currently moving).

A motion plan for the mobile device 104 reflecting the path preference is generated. The motion plan may specify various actions for movement by the mobile device 104 to change speed, start, and/or stop in the real world environment. For example, the preference representation 302 may present a representation of the path preference though a movement of the representation 304 of the mobile device 104 proportional to the speed change within the scene context 306. A speed increase may move the representation 304 of the mobile device 104 forward relative to the scene context 306, and a speed decrease may move the representation 304 of the mobile device 104 backward relative to the scene context 306. Similarly, starting may move the representation 304 of the mobile device 104 relative to the scene context 306, while stopping may cease movement of the representation 304 of the mobile device 104 relative to the scene context 306. Such a representation of the path preference may be presented as an animation of one or more icons within the scene context 306. For example, the representation 304 of the mobile device 104 may move within the scene context 306 to the indicated destination with other representations remaining stationary, the lane marker 700 may move within the scene context 306 with the representation 304 of the mobile device 104 remaining stationary, or some combination thereof. The actions of the motion plan may involve movements that are different than the representation of the path preference of the preference representation 302, such that the preference representation 304 is a simplified representation of movement to capture a path preference.

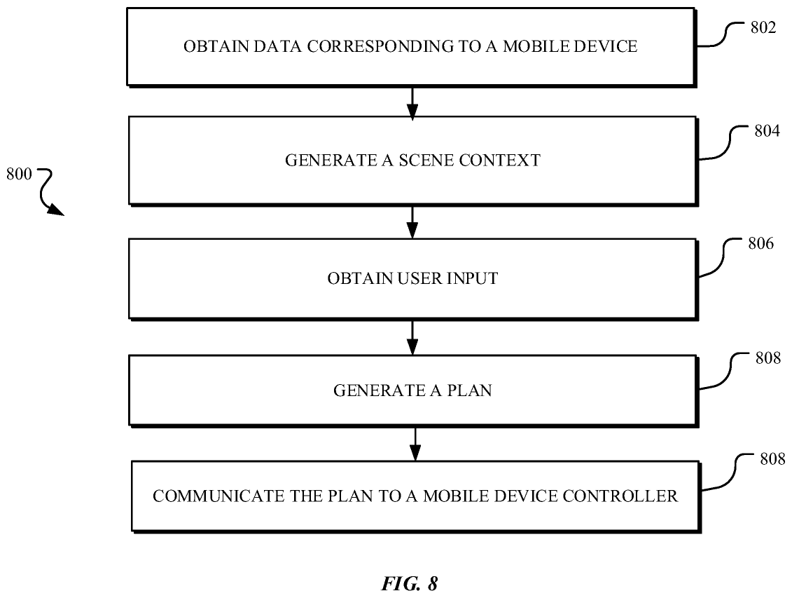

FIG. 8 illustrates example operations 800 for icon-based mobile device movement control. In one implementation, an operation 802 obtains data corresponding to a mobile device within a real world environment in which the mobile device is located. The data may include sensor data, location data, orientation data, and/or the like.

An operation 804 generates a mobile device icon representative of the mobile device and an icon-based scene context representative of a current position of the mobile device relative to at least one element of the real world environment using the data. The mobile device icon may be presented within the icon-based scene context using a presentation system. The presentation system may include a display, such as a touchscreen. It will be appreciated, however, that the presentation system may include other output devices, as described herein.

In addition to the current position of the mobile device, the icon-based scene context may be representative of a current orientation (e.g., heading, tilt, etc.) of the mobile device relative to the element(s) of the real world environment. The element(s) of the real world environment represented in the icon-based scene context may include, without limitation, lane markers, parking location(s), other mobile device(s) (e.g., vehicles), obstacle(s), external object(s), and/or the like. Such element(s) may be represented with one or more corresponding icons. The icon-based scene context may further include a representation of kinematic limits of available movements the mobile device from the current location. While the representation of the mobile device and scene context representative of the current position of the mobile device relative to the element(s) of the real world scene are described in the example of FIG. 8 as being icons and icon-based representations, it will be appreciated that the representations may take various forms and in some examples include photo-realistic elements or be composed at least in part of images of the mobile device and/or real world environment.

An operation 806 obtains user input representing a manipulation of the mobile device icon within the icon-based scene context. The user input may be captured using an input system, which may include one or more input devices, sensors, and/or the like. The presentation system and/or the input system may be integrated into an electronic device and/or the mobile device. The user input may be at least one of touch/tactile input, gesture input, voice input, device input (e.g., input captured using an input device), and/or the like. For example, the presentation system and/or the input system may include a touchscreen. The mobile device icon may be displayed with the touchscreen, and the user input may include tactile input captured using the touchscreen. In this example, the manipulation of the mobile device icon within the icon-based scene context may include dragging the mobile device icon along the touchscreen to an indicated position, rotating the mobile device icon about the touchscreen to an indicated orientation, and/or the like within the icon-based scene context. Additionally, the manipulation of the mobile device icon may include three degrees of freedom. For example, manipulation within two degrees of freedom provides the ability to control a position of the mobile device (e.g., in an x-direction and a y-direction), and manipulation within a third degree of freedom provides the ability to control an orientation of mobile device (e.g., a heading). In the example of the touchscreen, one touch point on the touchscreen controls a first degree of freedom (e.g., x-direction) and a second degree of freedom (e.g., y-direction) of the mobile device icon, and two touch points on the touchscreen controls a third degree of freedom (e.g., heading) of the mobile device icon. Thus, the mobile device icon may be manipulated in three degrees of freedom within the icon-based scene context.

An operation 808 generates a motion plan for the mobile device reflecting the manipulation of the mobile device icon. The motion plan may specify an action for movement by the mobile device. The motion plan may include parking, crabbing motion, changing lanes, avoiding an obstacle, turning, executing a U-turn, executing a three-point turn, stopping, reducing speed, increasing speed, starting, and/or the like. The action may include various operation(s) associated with moving the mobile device in accordance with executing the motion plan. An operation 810 communicates the motion plan to a mobile device controller for controlling the mobile device based on the motion plan. The motion plan may be communicated to the mobile device controller using various communication protocols. The mobile device controller may autonomously control the mobile device based on the motion plan. For example, the mobile device controller may generate a target and a trajectory in the real world environment based on the motion plan and autonomously move along the trajectory towards the target.

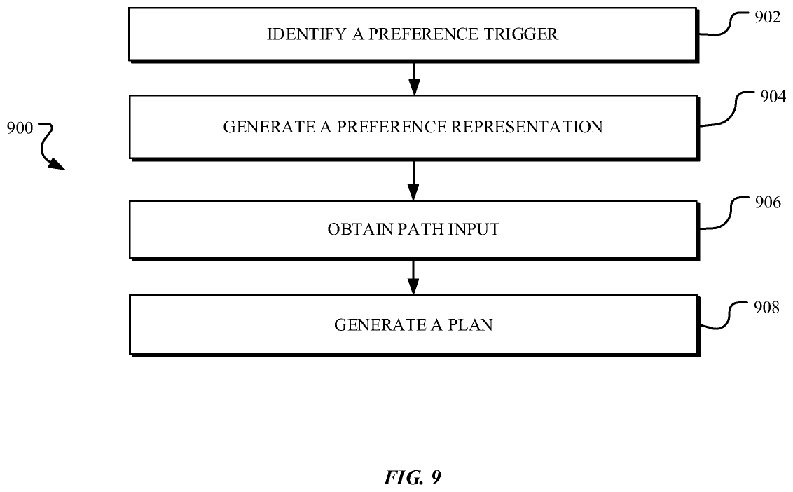

FIG. 9 illustrates example operations 900 for mobile device movement control. In one implementation, an operation 902 identifies a preference trigger associated with a path of a mobile device. The preference trigger may involve an ambiguity associated with a point along the path. The ambiguity may correspond to a presence of multiple operable paths associated with moving the mobile device. Stated differently, the preference trigger may be identified by detecting a plurality of operable paths for moving the mobile device. For example, the preference trigger may be identified based on a detection of an obstacle along the path and in some instances where multiple operable paths for moving the mobile device around the obstacle are present.

In another example, the preference trigger may be identified based on a movement command, such as a lane change command, an increase speed command, a decrease speed command, a stopping command, a starting command, a choreographed movement command, a movement task command, a position change command, an orientation change command, and/or other command for controlling movement of the mobile device. The movement command may be obtained based on user input (e.g., tactile input, visual input, audio input, device input, etc.) captured using an input system.

In another example, the preference trigger may be identified based on detection of a storage operation. The storage operation may be detected based on: a transition of the mobile device from a travel mode to a storage mode; a storage command; arrival of the mobile device near a destination, detection of one or more proximate parking locations; and/or the like.

An operation 904 generates a preference representation in accordance with identifying the preference trigger. The preference representation includes a representation of the mobile device within a scene context representative of a current position and/or a current orientation of the mobile device relative to at least one element of a real world environment in which the mobile device is located. The scene context may further include a representation of kinematic limits of available movements of the mobile device from the current location. The element(s) of the real world environment represented in the scene context may include, without limitation, lane markers, parking location(s), other mobile device(s) (e.g., vehicles), obstacle(s), external object(s), and/or the like. Such element(s) and/or the mobile device may be represented with one or more corresponding icons, photorealistic features, and/or images.

As described above, a plurality of operable paths for moving the mobile device may be available. In one example, the preference representation includes the operable paths presented within the scene context (e.g., relative to an obstacle). A suggested path may be identified from the plurality of operable paths and presented in accordance with the preference representation.

In one implementation, the preference representation is generated using a motion controller. The preference representation may be output for presentation using a presentation system. The presentation system and the input system may be housed in an electronic device and/or form part of the mobile device. The preference representation may be presented as an interactive interface, such that a user may interact with the preference representation and user input is captured using the input system. The user input may include tactile, visual, audio, and/or device input. For example, the user input may include a path input. An operation 906 obtains the path input specifying a path preference. The path preference may be specified through a manipulation of the representation of the mobile device.

The manipulation of the representation of the mobile device may include moving the representation of the mobile device to an indicated destination. The indicated destination may include an indicated position and/or an indicated orientation within the scene context. The manipulation of the representation of the mobile device may include moving the representation of the mobile device along a plane (e.g., an x-y plane) to an indicated position within the scene context. For example, the representation of the mobile device may be moved in an x-direction and/or a y-direction from the current position to the indicated position. The manipulation of the representation of the mobile device may similarly include rotating the representation of the mobile device within the plane to an indicated orientation within the scene context. The plane may correspond to a touchscreen of the presentation system and/or the input system. It will be appreciated, however, that other manipulations of the representation of the mobile device are contemplated, such as tactile-based, visual-based, audio-based, and/or device-based manipulations.

In one implementation, the manipulation of the representation of the mobile device includes three degrees of freedom. For example, manipulation within two degrees of freedom provides the ability to control a position of the representation of the mobile device (e.g., in an x-direction and a y-direction), and manipulation within a third degree of freedom provides the ability to control an orientation of the representation of the mobile device (e.g., heading, tilting, etc.). In the example of the touchscreen, a first gesture (e.g., one touch point on a touchscreen) may control a first degree of freedom (e.g., x-direction) and a second degree of freedom (e.g., y-direction) of the representation of the mobile device, and a second gesture (e.g., two touch points on the touchscreen) controls a third degree of freedom (e.g., heading) of the representation of the mobile device. Thus, the representation of the mobile device may be manipulated in three degrees of freedom within the scene context.

An operation 908 generates a motion plan for the mobile device reflecting the path preference. The motion plan specifies an action for movement by the mobile device. For example, the path preference may specify an indicated destination (e.g., an indicated position, indicated orientation, etc.), such that the action of the motion plan is adapted for moving the mobile device towards a destination reflecting the indicated destination. One or more device systems of the mobile device may be controlled in accordance with the motion plan, for example using a mobile device controller. The motion plan may include parking, crabbing motion, changing lanes, avoiding an obstacle, turning, executing a U-turn, executing a three-point turn, stopping, reducing speed, increasing speed, starting, choreographed movement, and/or the like. The action may include various operation(s) associated with moving the mobile device in accordance with executing the motion plan. The motion plan may be communicated to the mobile device controller for controlling the mobile device based on the motion plan. The motion plan may be communicated to the mobile device controller using various communication protocols. The mobile device controller may autonomously control the mobile device based on the motion plan. For example, the mobile device controller may generate a target and a trajectory in the real world environment based on the motion plan and autonomously move along the trajectory towards the target. The target may correspond to a destination reflecting an indicated destination of the path preference. As another example, one or more device systems, such as one or more actuators, of the mobile device may be controlled in accordance with the motion plan.

Movement of the mobile device along the path may be paused at a pausing point in accordance with detection of an obstacle, identification of an ambiguity, detection of a parking operation, and/or otherwise in accordance with an identification of a preference trigger. In one example, one or more options or available operable paths for moving the mobile device (e.g., around an obstacle towards a destination) may be presented using the preference representation as the mobile device is approaching a point associated with a preference trigger (e.g., an obstacle location) and prior to the pausing point. Similarly, movement along the path of the mobile device may be paused in response to an absence of the path input. After obtaining the path input, motion of the mobile device may be resumed. If no path input is received and a suggested operable path is identified, motion of the mobile device may be resumed following an elapse of a predetermined period of time. In some examples, the presentation of the available operable paths and receipt of path input occurs prior to the pausing point, such that the movement of the mobile device is not paused and movement of the mobile device continues according to motion plan.

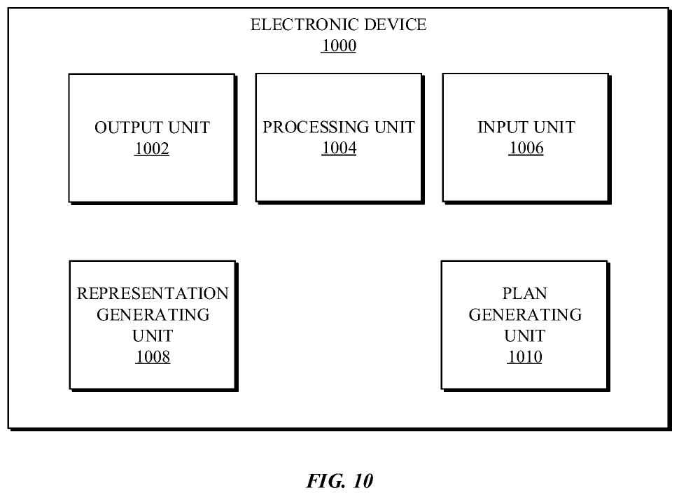

Turning to FIG. 10, an electronic device 1000 including operational units 1002-1010 arranged to perform various operations of the presently disclosed technology is shown. The operational units 1002-1010 of the device 1000 are implemented by hardware or a combination of hardware and software to carry out the principles of the present disclosure. It will be understood by persons of skill in the art that the operational units 1002-1010 described in FIG. 10 may be combined or separated into sub-blocks to implement the principles of the present disclosure. Therefore, the description herein supports any possible combination or separation or further definition of the operational units 1002-1010.

In one implementation, the electronic device 1000 includes an output unit 1002 configured to output information (e.g., for presentation) using one or more output devices or systems, a processing unit 1004, and an input unit 1006 configured to receive data from one or more input devices or systems. Various operations described herein may be implemented by the processing unit 1004 using data received by the input unit 1006 to output information for presentation following output using the output unit 1002.

Additionally, in one implementation, the electronic device 1000 includes units implementing the operations described with respect to FIG. 9. For example, the operation 904 may be implemented using a representation generating unit 1008, and the operation 908 may be implemented using the motion plan generating unit 1010. Other operations described herein may be implemented using the units 1008-1010 and/or other operational units of the electronic device 1000.

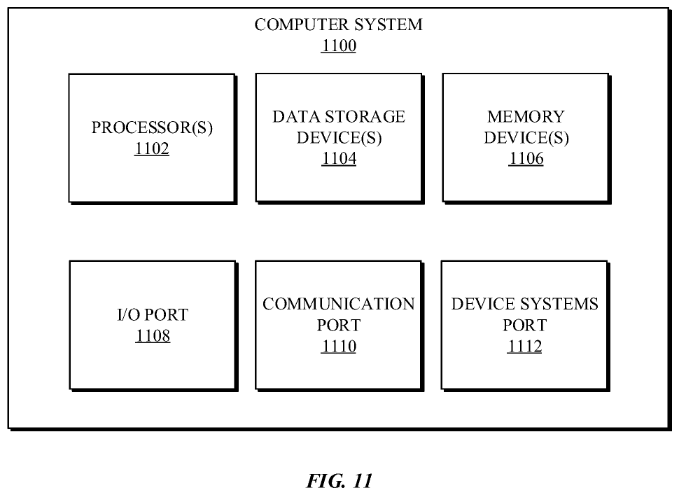

Referring to FIG. 11, a detailed description of an example computing system 1100 having one or more computing units that may implement various systems and methods discussed herein is provided. The computing system 1100 may be applicable to the electronic device 102, the mobile device 104, the presentation system 106, the input system 108, the motion controller 110, the mobile device controller 112, the device systems 114, the electronic device 1000, and/or the like. It will be appreciated that specific implementations of these devices may be of differing possible specific computing architectures not all of which are specifically discussed herein but will be understood by those of ordinary skill in the art.

The computer system 1100 may be a computing system is capable of executing a computer program product to execute a computer process. Data and program files may be input to the computer system 1100, which reads the files and executes the programs therein. Some of the elements of the computer system 1100 are shown in FIG. 11, including one or more hardware processors 1102, one or more data storage devices 1104, one or more memory devices 1106, and/or one or more ports 1108-1112. Additionally, other elements that will be recognized by those skilled in the art may be included in the computing system 1100 but are not explicitly depicted in FIG. 11 or discussed further herein. Various elements of the computer system 1100 may communicate with one another by way of one or more communication buses, point-to-point communication paths, or other communication means not explicitly depicted in FIG. 11.

The processor 1102 may include, for example, a central processing unit (CPU), a microprocessor, a microcontroller, a digital signal processor (DSP), and/or one or more internal levels of cache. There may be one or more processors 1102, such that the processor 1102 comprises a single central-processing unit, or a plurality of processing units capable of executing instructions and performing operations in parallel with each other, commonly referred to as a parallel processing environment.

The computer system 1100 may be a conventional computer, a distributed computer, or any other type of computer, such as one or more external computers made available via a cloud computing architecture. The presently described technology is optionally implemented in software stored on the data stored device(s) 1104, stored on the memory device(s) 1106, and/or communicated via one or more of the ports 1108-1112, thereby transforming the computer system 1100 in FIG. 11 to a special purpose machine for implementing the operations described herein.

The one or more data storage devices 1104 may include any non-volatile data storage device capable of storing data generated or employed within the computing system 1100, such as computer executable instructions for performing a computer process, which may include instructions of both application programs and an operating system (OS) that manages the various components of the computing system 1100. The data storage devices 1104 may include, without limitation, magnetic disk drives, optical disk drives, solid state drives (SSDs), flash drives, and the like. The data storage devices 1104 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1106 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1104 and/or the memory devices 1106, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1100 includes one or more ports, such as an input/output (I/O) port 1108, a communication port 1110, and a device systems port 1112, for communicating with other computing, network, or mobile device system devices (e.g., vehicle systems, devices, or sub-systems). It will be appreciated that the ports 1108-1112 may be combined or separate and that more or fewer ports may be included in the computer system 1100.

The I/O port 1108 may be connected to an I/O device, or other device, by which information is input to or output from the computing system 1100. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1100 via the I/O port 1108. Similarly, the output devices may convert electrical signals received from computing system 1100 via the I/O port 1108 into signals that may be sensed as output by a human, such as sound, light, and/or touch. The input device may be an alphanumeric input device, including alphanumeric and other keys for communicating information and/or command selections to the processor 1102 via the I/O port 1108. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touchscreen. The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1100 via the I/O port 1108. For example, an electrical signal generated within the computing system 1100 may be converted to another type of signal, and/or vice-versa. In one implementation, the environment transducer devices sense characteristics or aspects of an environment local to or remote from the computing device 1100. Further, the environment transducer devices may generate signals to impose some effect on the environment either local to or remote from the example computing device 1100.

In one implementation, the communication port 1110 is connected to a network by way of which the computer system 1100 may receive network data useful in executing the methods and systems set out herein as well as transmitting information and network configuration changes determined thereby. Stated differently, the communication port 1110 connects the computer system 1100 to one or more communication interface devices configured to transmit and/or receive information between the computing system 1100 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1110 to communicate one or more other machines, either directly over a point-to-point communication path, over a wide area network (WAN) (e.g., the Internet), over a local area network (LAN), over a cellular network, or over another communication means. Further, the communication port 1110 may communicate with an antenna for electromagnetic signal transmission and/or reception. In some examples, an antenna may be employed to receive Global Navigation Satellite System (GNSS) data, that may be captured for example using Global Positioning System (GPS), GLONASS Galileo, Beidou, and/or regional systems to facilitate determination of a location of a machine, vehicle, or another device.

The computer system 1100 may include the device systems port 1112 for communicating with one or more systems related to the mobile device 104 to control an operation of the mobile device 104 and/or exchange information between the computer system 1100 and one or more systems of the mobile device 104 or the electronic device 102. Non-limiting examples of such device systems of a mobile device include, without limitation, imaging systems, radar, LIDAR, motor controllers and systems, battery control, fuel cell or other energy storage systems or controls in the case of such vehicles with hybrid or electric motor systems, autonomous or semi-autonomous processors and controllers, steering systems, brake systems, light systems, navigation systems, environment controls, entertainment systems, and the like.

In an example implementation, information, software and other modules and services for mobile device movement control and representation-based control may be embodied by instructions stored on the data storage devices 1104 and/or the memory devices 1106 and executed by the processor 1102. The computer system 1100 may be integrated with or otherwise form part of the mobile device 104 and/or the electronic device 102. In some instances, the computer system 1100 is an electronic device that is portable may be in communication and working in conjunction with various systems or sub-systems.

The present disclosure recognizes that the use of information corresponding to mobile device movement control and representation-based interaction and control may be used to the benefit of users. While location information may inform mobile device movement and navigation, it is recognized that collection and use of such information should be performed in a privacy-respectful manner. Users can selectively block use of, or access to, personal data, such as location or other information. For example, the system can allow users to “opt in” or “opt out” of participation in the collection of personal data or portions thereof. Also, users can select not to provide location information, or permit provision of general location information (e.g., a geographic region or zone) but not precise location information. Implementers are reminded to abide by applicable privacy laws and practices.

The system set forth in FIG. 11 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
identifying a preference trigger associated with a path of a mobile device;
presenting a preference representation in accordance with identifying the preference trigger using a display, the preference representation including a representation of the mobile device presented within a scene context indicative of a current position of the mobile device relative to at least one element of a real world environment in which the mobile device is located;
obtaining a path input specifying a path preference, the path input captured using an input device, the path preference specified through a manipulation of the representation of the mobile device; and
generating a motion plan for the mobile device reflecting the path preference, the motion plan specifying an action for movement by the mobile device.

2. The method of claim 1, wherein identifying the preference trigger comprises detecting an obstacle along the path of the mobile device.

3. The method of claim 2, wherein identifying the preference trigger further comprises identifying a plurality of operable paths for moving the mobile device around the obstacle.

4. The method of claim 2, wherein the at least one element of the real world environment includes the obstacle.

5. The method of claim 2, wherein motion along the path of the mobile device is paused in response to detection of the obstacle along the path.

6. The method of claim 1, wherein motion along the path of the mobile device is paused in response to an absence of the path input.

7. The method of claim 1, wherein the path preference specifies a destination, and wherein the action of the motion plan is adapted for moving the mobile device towards the destination.

8. One or more tangible non-transitory computer-readable storage media storing computer-executable instructions for performing a computer process on a computing system, the computer process comprising:
identifying a preference trigger associated with a path of a mobile device;
generating a preference representation in accordance with identifying the preference trigger, the preference representation including a representation of the mobile device located within a scene context indicative of a current position of the mobile device relative to at least one element of a real world environment in which the mobile device is located;
obtaining a path input specifying a path preference, the path preference specified through a manipulation of the representation of the mobile device; and
generating a motion plan for the mobile device reflecting the path preference, the motion plan specifying an action for movement by the mobile device.

9. The one or more tangible non-transitory computer-readable storage media of claim 8, wherein identifying the preference trigger comprises obtaining a movement command.

10. The one or more tangible non-transitory computer-readable storage media of claim 8, wherein identifying the preference trigger comprises detecting a storage operation.

11. The one or more tangible non-transitory computer-readable storage media of claim 8, wherein the scene context includes a representation of kinematic limits of available movements of the mobile device from the current location.

12. The one or more tangible non-transitory computer-readable storage media of claim 8, wherein identifying the preference trigger comprises detecting an obstacle along the path of the mobile device.

13. The one or more tangible non-transitory computer-readable storage media of claim 8, wherein identifying the preference trigger comprises detecting a plurality of operable paths for moving the mobile device.

14. The one or more tangible non-transitory computer-readable storage media of claim 8, wherein the path preference specifies a destination, and wherein the action of the motion plan is adapted for moving the mobile device towards the destination.

15. The one or more tangible non-transitory computer-readable storage media of claim 8, further comprising:
controlling one or more device systems of the mobile device in accordance with the motion plan.

16. A system comprising:
a motion controller generating a preference representation in accordance with identifying a preference trigger associated a path of a mobile device;
a presentation system presenting the preference representation, the preference representation including a representation of the mobile device presented within a scene context indicative of a current position of the mobile device relative to at least one element of a real world environment in which the mobile device is located; and
an input system capturing a path input specifying a path preference, the path preference specified through a manipulation of the representation of the mobile device, the motion controller generating a motion plan for the mobile device reflecting the path preference, the motion plan specifying an action for movement by the mobile device.

17. The system of claim 16, wherein the manipulation of the representation of the mobile device includes moving the representation of the mobile device along a plane.

18. The system of claim 16, wherein the manipulation of the representation of the mobile device includes moving the representation of the mobile device to an indicated position.

19. The system of claim 16, further comprising:
a mobile device controller controlling one or more device systems of the mobile device in accordance with the motion plan.

20. The system of claim 16, wherein the presentation system and the input system are housed in an electronic device.
